(19) United States
(12) Patent Application Publication
(10) Pub. No.: US 2002/0106936 A1
(43) Pub. Date: Aug. 8, 2002

(54) Connection element for connecting a semi-rigid coaxial conductor

(76) Inventor: Roland Baur, Villingen-Schwenningen (DE)

Correspondence Address: Samuels, Gauthier & Stevens LLP, Suite 3300, 225 Franklin Street, Boston, MA, 02110, US

(21) Appl. No.: 10/032,696

(22) Filed: Dec. 28, 2001

(30) Foreign Application Priority Data
Dec. 28, 2000 (DE) 100 65 586.6

(51) Int. Cl. H01R 9/05

(52) U.S. Cl. 439/578

(57) ABSTRACT

To fasten a connection element on the end of a semi-rigid coaxial conductor without special tools, in a mechanically strong, HF-tight, water- and gas-tight connection, a tubular connection piece having an outer thread and an inner tapered section is situated on one connection side of a casing. A union nut with an opening for passing through the outer conductor of the semi-rigid coaxial conductor can be screwed on the outer thread of the connection piece. A locking bushing having a deformable tapered section is situated between the inner face of the union nut and the connection piece. The locking bushing can be pressed into the inner tapered section of the connection piece. It has a surface grip on the outer conductor of the semi-rigid coaxial conductor. By tightening the union nut, the locking bushing together with the outer conductor is pressed into the inner tapered section of the connection piece. The deformable tapered section of the locking bushing thus fits itself positively to the inner tapered section of the connection piece, forming a mechanically strong, HF-, water-, and gas-tight press seat. The inner conductor of the semi-rigid coaxial conductor is pressed against the end of an inner conductor, which is situated centrally in the housing. The connection element can be fastened without special tools—and if the union nut is knurled, even without any tools—and with only little handling.

### BACKGROUND OF THE INVENTION

The invention relates to the field of electrical connectors, and in particular to a connection element for connecting a semi-rigid coaxial conductor with a casing that contains a central inside conductor.

In contrast to flexible coaxial conductors whose outside conductor is constructed as a wire braid, semi-rigid coaxial conductors have a semi-rigid outer conductor (e.g., copper tubing). A semi-rigid outside conductor achieves better high frequency (HF) shielding and higher precision than a flexible outside conductor. As a result, semi-rigid coaxial conductors are especially well suited to transmit high frequencies.

The connection ends of a semi-rigid coaxial conductor connect to elements such as for example plug connectors, plugs, receptacles, or the like. These transmit the high frequencies transmitted on a semi-rigid coaxial conductor with relatively little attenuation and reflection. However, it should also be possible to make a mechanically strong connection of such a connection element to the connection end of a semi-rigid coaxial conductor without special tools and without much handling.

Therefore, there is a need for a connection element for connecting a semi-rigid coaxial conductor, without special tools and with little handling, so that the connection is mechanically strong, HF-tight, and water- and gas-tight.

### SUMMARY OF THE INVENTION

Briefly, according to an aspect of the invention, a connection element for connecting a semi-rigid coaxial conductor, includes a casing and a tubular connection piece extending from the casing. The tubular connection piece has an outer thread and inner tapered section. The connection element also includes a locking bushing that has a deformable tapered section. The connection element further comprises and a nut. The outer conductor is pressed with a positive interlock into the tapered section when the outer conductor is seated on the deformable tapered section and the nut is screwed onto the outer thread.

In one aspect of the invention, the tube-shaped connection piece has an outer thread and an inner tapered section that is situated at the casing, on the side where the semi-rigid coaxial conductor connects. The casing and the connection piece preferably are constructed in one piece. The connection piece consequently is incorporated into the casing. An inside conductor is seated in the center of the casing.

The locking bushing has a deformable tapered section that adjoins a gripping surface on the inner face of a union nut, which can be screwed together with the outer thread of the connection piece. By screwing in and tightening the union nut, the locking bushing can be pressed into the inside tapered section of the connection piece so as to make a positive connection. Due to the deformability of the tapered section, a mechanically strong and even water- and gas-tight seat as well as an HF-tight electric contact is formed at the locking bushing when the union nut is tightened. When the union nut is tightened, the deformable tapered section of the locking bushing fits to make a positive connection to the inside tapered section of the tube-shaped connection piece.

A circular opening to pass the outer conductor of the semi-rigid coaxial conductor is machined into the face of the union nut. To fasten the connection element, the union nut and the locking bushing are put on the outside conductor of the semi-rigid coaxial conductor. Then the tube shaped connection piece is put on the end of the semi-rigid coaxial conductor, and the union nut is screwed on the tube shaped connection piece, while the locking bushing with the deformable tapered section that surrounds the outside conductor is pressed into the inner tapered section of the connection piece. As a result, the outside conductor and the locking bushing thus are mechanically seated and HF-, water-, and gas-tight in the inside tapered section of the connection piece. At the same time, the end of the inside conductor of the semi-rigid coaxial conductor is pressed solidly against the end of the central inside conductor of the casing.

Depending on the particular design of the inventive connection element, the outside conductor of the semi-rigid coaxial conductor can be stuck through the opening in the union nut provided for it and into the locking bushing. Then the union nut only needs to be tightened to fasten the connection element solidly to the outside conductor of the semi-rigid coaxial conductor, as described above. The union nut and the locking bushing are first pushed on the semi-rigid coaxial conductor.

The connection opposite the connection of the outside conductor can be constructed as a mirror image, so that the connection element serves as a coupling for two semi-rigid coaxial conductors, whose diameters may also be different. The second connection can also be a receptacle or a plug to connect a coaxial cable or another line. The two connections can be situated opposite one another, but they can also be situated at an arbitrary angle to one another.

The central inside conductor of the inventive connection element is mounted, for example in a sheath-like insulating part, which is situated in the casing.

The casing, the locking bushing, and the union nut are preferably made of metal.

These and other objects, features and advantages of the present invention will become more apparent in light of the following detailed description of preferred embodiments thereof, as illustrated in the accompanying drawings.

### BRIEF DESCRIPTION OF THE DRAWING

FIG. 1 illustrates an embodiment of an inventive connection element in perspective;

FIG. 2 illustrates a side view of the connection element; and

FIG. 3 illustrates a longitudinal section through the connection element.

### DETAILED DESCRIPTION OF THE INVENTION

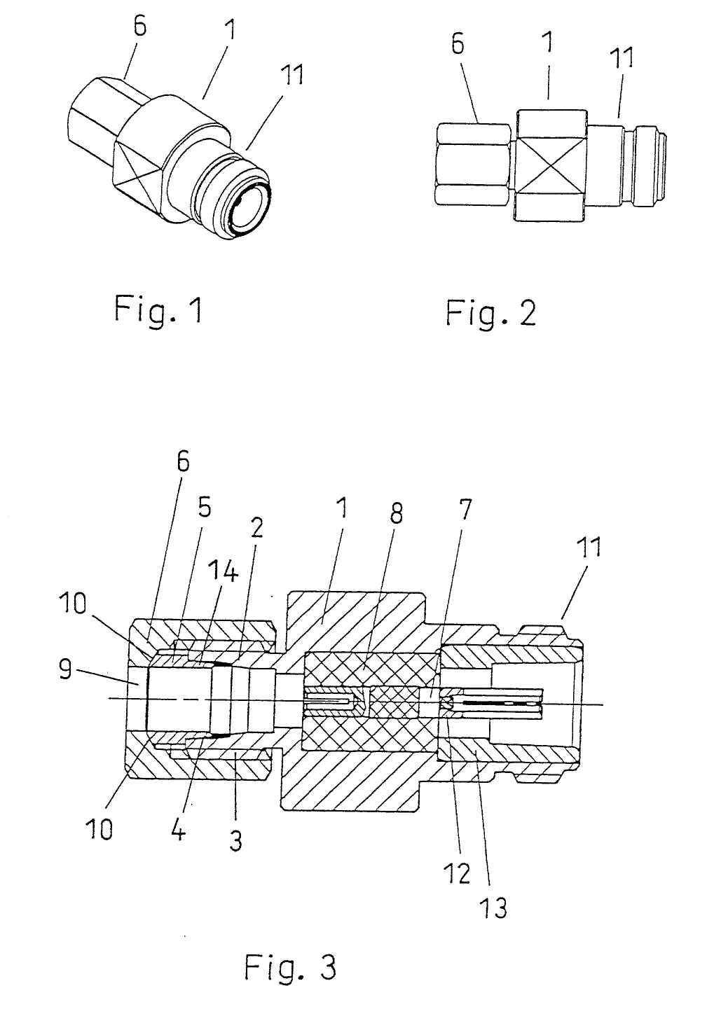

Referring to FIGS. 1-3, a union nut 6 is screwed on a tube-shaped connection piece 2, which forms the connection for a semi-rigid coaxial conductor. A housing 1 has a second connection 11, which is situated opposite the tube-shaped connection piece 2. The second connection 11 is constructed as a receptacle. The union nut 6 is preferably a hexagon nut.

Referring to FIG. 3 the connection piece 2 has an outside thread 3 and an inside tapered section 4. The connection piece 2 is situated at the housing 1 on the side where the outer conductor of the semi-rigid coaxial conductor connects. The face of the union nut 6 has an opening 9 for the outer conductor, and the union nut 6 is screwed onto the outside thread 3 of the connection piece 2. A locking bushing 5 with a deformable tapered section 14 is situated between the inner face of the union nut 6 and the connection piece 2. The locking bushing 5 is seated partly in the inside tapered section 4. The face of the locking bushing 5 adjoins a gripping surface 10 on the inner face of the union nut 6.

A first central inner conductor 7 is fastened centrally in the interior of the casing 1 by a first insulating part 8. Another inside conductor 12 adjoins the central inside conductor 7. The inside conductor 12 extends freely into a sheath-like insulating part 13, to form a receptacle.

The outer conductor of the semi-rigid coaxial conductor, which is not shown in FIG. 3 for the sake of clarity, is seated in the locking bushing 5 with the deformable tapered section 14. It is pressed with the locking bushing 5 into the inside tapered section 4 of the connection piece 2 when the union nut 6 is tightened. As a result, the locking bushing 5 and the outer conductor are seated in a positive, water-, gas-, and HF-tight press fit in the inner tapered section 4 of the connection piece 2.

To fasten the inventive connection element to the outer conductor of the semi-rigid coaxial conductor, for example the union nut 6 and the locking bushing 5 are first placed on the outer conductor. Then the connection piece 2, with the inner tapered section 4, is placed on the outer conductor. Now the union nut 6 only needs to be tightened on the outer thread 3 of the connection piece 2, so that the outer conductor, which makes a surface contact with the locking bushing 5, will be connected to the connection element in a mechanically strong, HF-tight, and also water- and gas-tight connection.

In one embodiment of the inventive connection element, the outer conductor can be stuck into the locking bushing 5 through the opening 9 of the union nut 6, which is screwed loosely on the outer thread 3 of the connection piece 2. By tightening the union nut 6, the outer conductor of the semi-rigid coaxial conductor makes a mechanically strong, HF-tight, as well as water- and gas-tight connection with the connection piece 2 of the casing 1. The gripping surface 10 of the union nut 6 presses the locking bushing 5 with the outer conductor into the inner tapered section 4 of the connection piece 2.

The second connection of the inventive connection element can be situated opposite the first connection or at an arbitrary angle to it.

The second connection can be a mirror image of the first one, so that the inventive connection element couples two semi-rigid coaxial conductors to one another. However, the diameters of these two coaxial conductors may also be different.

The union nut 6, the locking bushing 5, and the casing 1 are made of an electrically conducting material, such as, for example, metal.

An advantage of the invention is that the outer conductor of a semi-rigid coaxial conductor makes a mechanically strong, HF-tight as well as water- and gas-tight connection with the inventive connection element, due to the surface grip of the locking bushing. Even though the inventive connection element makes a mechanically strong, and also HF-tight, water- and gas-tight connection to the outside conductor of a semi-rigid coaxial conductor, the invention is further characterized by a second advantage, namely that the connection element can be fastened to the end of a semi-rigid coaxial conductor without special tools and with only little handling. A customary wrench is sufficient for this. However, the union nut can also be knurled, so that no tools at all are needed anymore.

Although the present invention has been shown and described with respect to several preferred embodiments thereof, various changes, omissions and additions to the form and detail thereof, may be made therein, without departing from the spirit and scope of the invention.

What is claimed is:

1. A connection element for connecting a semi-rigid coaxial conductor having an outer conductor which comprises:
a casing;
a tubular connection piece extending from the casing, said tubular connection piece having an outer thread and inner tapered section; and
a locking bushing having a deformable tapered section; and
a nut, said outer conductor being pressed with a positive interlock into said tapered section when said outer conductor is seated on said deformable tapered section and said nut is screwed onto said outer thread.

2. The connection element of claim 1 wherein said nut has an opening, configured and arranged to receive said outer conductor.

3. The connection element of claim 2 wherein said nut has an outside face that is gripped, said outside face contacting the locking bushel.

4. The connection element of claim 3, further comprising:
a receptacle positioned opposite to or optionally at an arbitrary angle to the tubular connection piece.

5. The connection element of claim 4, further comprising:
an inner conductor; and
a sheath-shaped insulating part, said inner conductor being seated in said sheath-shaped insulating part, said sheath-shaped insulating part being centrally positioned within said casing.

6. The connection element of claim 5 wherein said casing, said locking bushel and said nut are metal.

7. The connection element of claim 3, wherein said tubular connection piece is a first tubular connection piece, said locking bushel is a first locking bushel and said nut is a first nut, and said connection element further comprises:
a second tubular connection piece extending from said casing opposite to or optionally at an arbitrary angle to said first tubular connection piece, said second tubular connection piece having an outer thread and inner tapered section;
a second locking bushing having a deformable tapered section; and
a second nut, wherein said outer conductor being pressed with a positive interlock into said second tapered section when said outer conductor is seated on said deformable tapered section and said second nut is screwed onto said outer thread.

8. The connection element of claim 7, wherein said casing, said first and second locking bushels and said first and second nuts are electrically conductive.

9. A connection element for connecting a semi-rigid coaxial conductor having an outer conductor to a casing, said connection element comprising:
a tubular connection piece constructed to extend from the casing, said tubular connection piece having an outer thread and an inner tapered section;
a locking bushing having a deformable tapered section; and
a nut, wherein the outer conductor being pressed with a positive interlock into said tapered section when the outer conductor is seated on said deformable tapered section and said nut is screwed onto said outer thread.
